(19) United States
(12) Patent Application Publication
(10) Pub. No.: US 2021/0204021 A1
(43) Pub. Date: Jul. 1, 2021

(54) SYSTEMS AND METHODS FOR MANAGING INFOTAINMENT BUFFER IN A VEHICLE

(71) Applicant: Harman International Industries, Incorporated, Stamford, CT (US)

(72) Inventors: Aashish Kumar, Bangalore (IN); Ankur Jha, Bangalore (IN); Rajesh Biswal, Bangalore (IN)

(21) Appl. No.: 17/133,477

(22) Filed: Dec. 23, 2020

Related U.S. Application Data
(60) Provisional application No. 62/954,206, filed on Dec. 27, 2019.

(51) Int. Cl. H04N 21/44; H04L 29/06; H04N 21/845

(52) U.S. Cl. CPC H04N 21/44004; H04N 21/8456; H04L 65/4084

(57) ABSTRACT

Methods and systems are provided for managing streaming media content from a content provider in a vehicle infotainment system by predicting an upcoming region of degraded data communication, adjusting a size of a media content buffer in response to the upcoming region of degraded data communication, and playing the buffered media content during an interrupted communication with the content provider. In this way, a probability of media content streaming interruption/latency may be reduced.

### CROSS REFERENCE TO RELATED APPLICATION

The present application claims priority to provisional patent application No. 62/954,206, filed on Dec. 27, 2019. The entire contents of the above-listed application are hereby incorporated by reference for all purposes.

### BACKGROUND

The disclosure relates to managing a data buffer including vehicle infotainment data, as well as related operations.

### SUMMARY

Vehicles provide various information and services, such as streaming services, for in-vehicle infotainment systems. However, regions of reduced data connectivity, such as Internet dark-spots where data connectivity may be reduced or completely lacking, may interrupt streaming services. While buffering can mitigate such data communication degradations, increased buffer sizes can consume substantial memory and processing power, reducing system performance and responsiveness.

The inventors herein have realized a priori information related to timing and location of reduced connectivity locations, including estimated starting locations and ending locations, and estimated starting and ending times, can be used with knowledge of vehicle operating conditions and intended navigation course to dynamically adjust buffers to enable uninterrupted streaming even when passing through locations such as Internet dark-spots, or during times of increased network latency.

In a first example, a probability of streaming service degradation may be reduced by a method for managing streaming media in a vehicle, comprising, buffering streaming media data from a data source in a data buffer in the vehicle, the buffer adjusted based on an upcoming data communication degradation; and playing the buffered media data during an interrupted communication with the data source. By dynamically adjusting buffer size based on predicted dark-spots/regions of data communication degradation, and further based on vehicle operating conditions, a reduced probability of media streaming degradation may be achieved, while simultaneously reducing memory and processor utilization compared to methods relying on a statically increased buffer size.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example partial view of a vehicle cabin in accordance with one or more embodiments of the present disclosure;

FIG. 2 shows an example in-vehicle computing system in accordance with one or more embodiments of the present disclosure;

FIG. 3 shows an example block diagram illustration of a system with caching of content associated with dark-spots;

FIG. 4 is a flow chart of an example method for caching streaming data in an adjustable sized buffer in the example system of FIGS. 1-3;

FIG. 5 is a diagram depicting data flow for the method of FIG. 4;

FIG. 6 is a schematic diagram of a system agent for use with the systems of FIGS. 1-3 and the method of FIG. 4; and

FIG. 7 schematically shows example routes and associated data download operation in accordance with one or more embodiments of the present disclosure.

### DETAILED DESCRIPTION

The present disclosure relates to managing one or more vehicle infotainment data buffers to aid streaming services, as well as related operations.

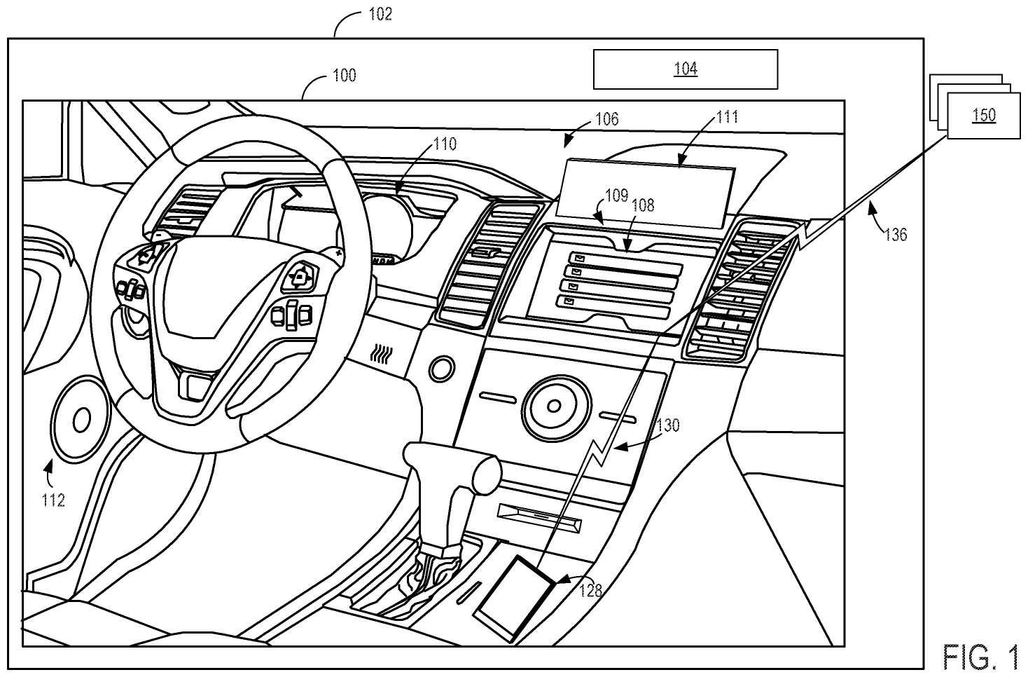

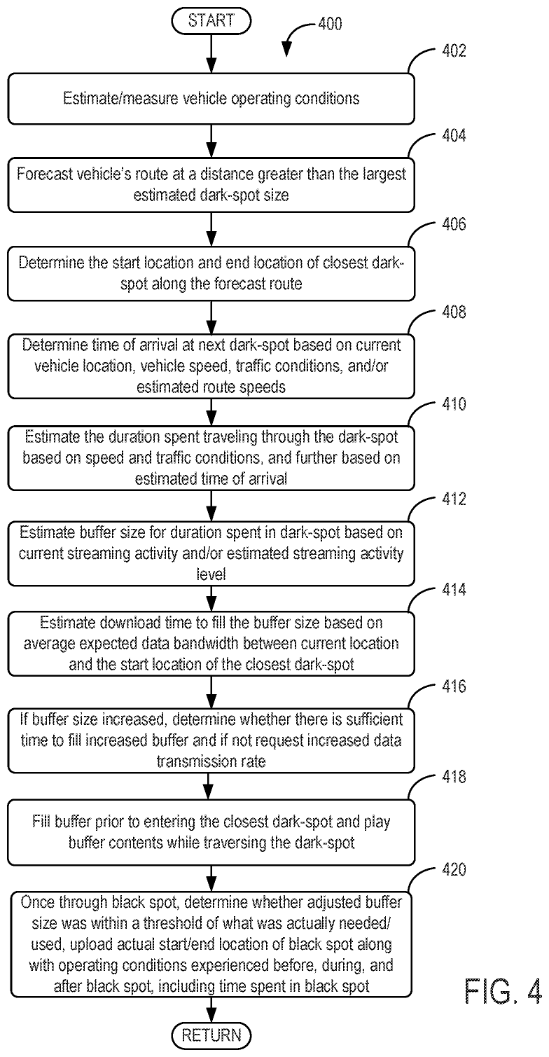

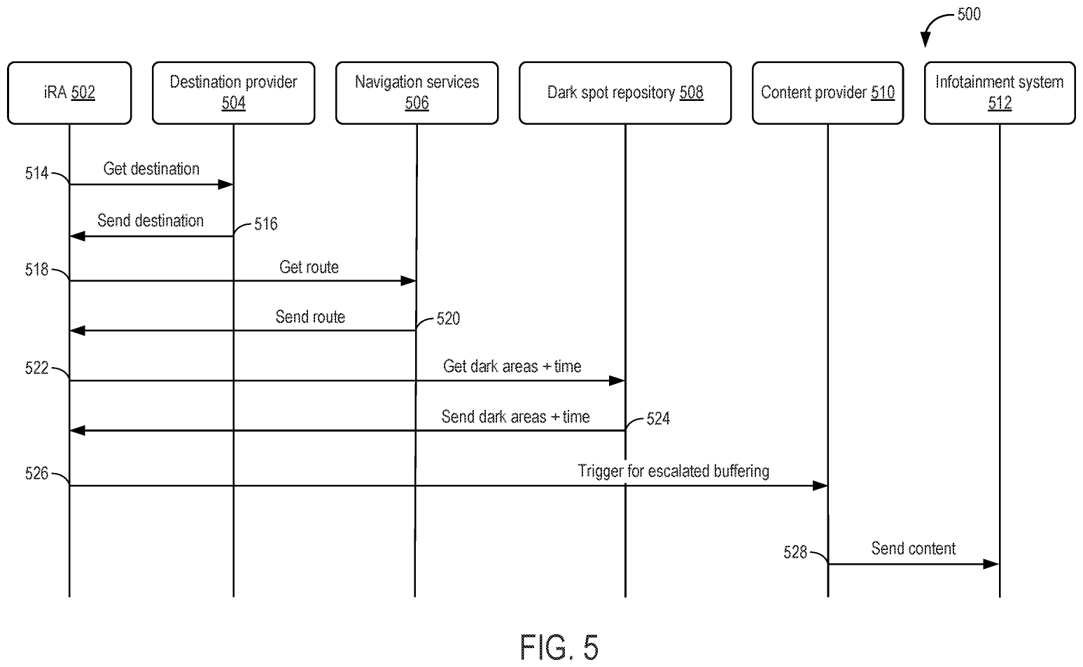

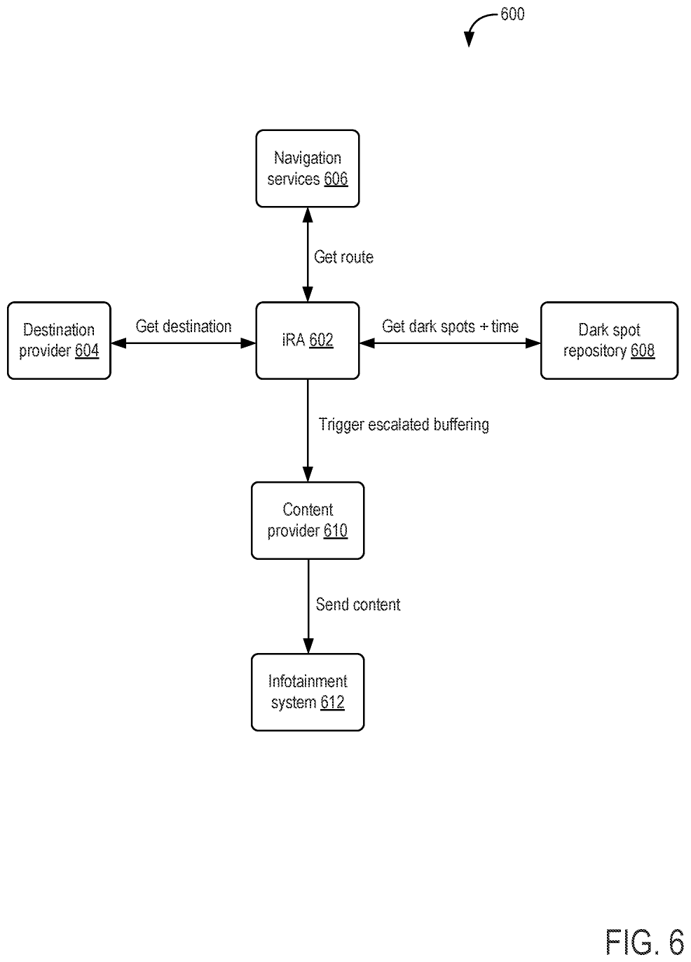

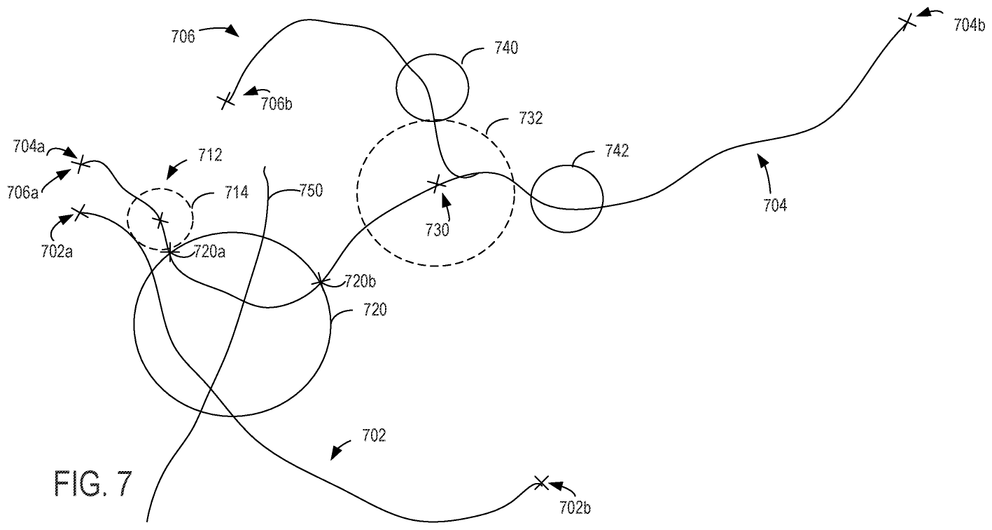

As shown in FIGS. 1-3, a system according to the present disclosure may be part of a vehicle, and methods described herein may be carried out via an in-vehicle computing system (also referred to herein as an infotainment system). FIG. 4 shows an example flowchart of a method 400, by which a vehicle computing system/infotainment system may predict regions of data connectivity degradation (also referred to herein as dark-spots, regions of data communication degradation, Internet dark-spots, and other similar terms) along a current route of travel, and may intelligently and dynamically adjust a size of a streaming media content buffer based on an estimated start location and end location of the predicted region of data connectivity degradation. FIG. 5 shows a communication diagram 500, illustrating communications which may occur between an intelligent reasoning agent (iRA) 502, a destination provider 504, navigation services 506, a dark-spot repository 508, a content provider 510, and a vehicle infotainment system 512, as part of a method for predicting dark-spots and dynamically adjusting streaming media content buffer size based thereon. FIG. 6 shows a system 600, capable of implementing the communications shown in FIG. 5. FIG. 7 schematically shows example routes 702, 704, and 706, along with corresponding dark-spots for each of the routes.

On-line streaming solutions reduce the amount of on-board data storage needs and provide access to a significantly greater variety of content. The content provider online system database from which media content is streamed may be located off-board the vehicle, such as in the cloud, and as a result the online system database can be updated at a single location with the latest changes or latest content available. However, a potential limitation with streaming media from remote content providers is that a constant and reliable connection to the cloud is needed to enable high quality streaming content and prevent streaming latency. Further, while the impact that regions of degraded data communication have on the operation of online systems may be mitigated with caching data ahead of time based upon a known route of travel, many caching techniques lack intelligence and are bound by memory constraints, or are overly costly.

Therefore, when navigating from one location to another, an intelligent agent may be provided in the vehicle that knows and/or learns the route of travel that the customer is going to take and potential locations of degraded connectivity (e.g., Internet dark-spots or regions of degraded data communication) that the customer will encounter. Based on a prediction of a start location and an end location of an upcoming dark-spot, and further based on an estimated duration of time to travel from the start location of the dark-spot to the end location of the dark-spot, the agent can trigger updating of an efficient streaming media content buffer management system, managed in the vehicle head unit/infotainment system, so that media content streaming can continue with reduced disruptions or latency, even while traveling through regions of degraded data connectivity.

As described herein, systems and methods are provided for adaptive learning of routes of travel and regions of degraded data communication along said routes of travel. In some embodiments, an initial model for predicting a route of travel and dark-spots along said route of travel is based on one or more of vehicle configuration, head unit model, and software level, and is updated during operation of the vehicle. Start locations and end locations of degraded data communication may be learned and updated by monitoring a level of data communication connectivity, as well as bandwidth and Internet connectivity, as a function of vehicle position a route of travel. Further, a desired strength/bandwidth of connectivity may be learned and included in maps of dark-spots, where the user sets the desired strength/bandwidth level to their preference. In this way, for users who may accept limited connectivity in certain regions, streaming media content buffer size may be maintained below a threshold buffer size even in regions of degraded data communication.

Cloud-based storage of start/end locations of dark-spots may enable crowd-sourced adaptive learning of dark-spot location, which may be stored on a remote server (herein referred to as a dark-spot repository). Start locations and end locations of dark-spots may be learned as a function of conditions, such as weather conditions, vehicle operating conditions, such as vehicle speed, vehicle orientation (e.g., due to variation in antenna performance depending on vehicle direction on the road, such as West vs. East on an east-west road), as a function of time etc. In the examples where the operating conditions include whether, the start locations and/or end locations of dark-spots may be learned as a function of the cloud level, such that during cloudy conditions the start/end locations may define a larger dark-spot than during sunny/clear locations for the same spot, as an example. The could-based database of start/end locations may also be adjusted based on factors external to the vehicle and micro-climate around the vehicle, such as based on status of various towers, in that if a tower is damaged by wind, etc., the start/end locations may be updated in the database in a feed-forward manner rather than, or in addition to, waiting until a sufficient number of vehicle have experience the dark-spot location changes to update the start/end locations in the on-line database.

Further, in an example in addition to or in the alternative to other examples herein, the same dark-spot size (including radius, for example), may be learned from multiple roads that pass through it, where the same vehicle or different vehicles may pass on different roads at different times or the same time (yet still update/learn information about the size (start/end locations) of the same dark-spot). For example, the dark-spot area and/or start/end locations may be learned based on the variation of the signal within the dark-spot yet along the route traveled by the vehicle as the vehicle may not travel in a straight line through the dark-spot. For, example, even a weak signal may provide information on the size of the dark-spot which may be used for other roads that may pass through the same dark-spot. In one approach, reduction in signal strength may be used to predict a center of a dark-spot, based on a model wherein signal strength decreases based on a non-linear relationship with the distance from a center point of a dark-spot.

Other vehicle operating conditions that may be included as a parameter upon which start/end locations of dark-spots are learned may include the density of surrounding traffic, whether the vehicle includes a loaded roof rack, geography/terrain along the route (such as valleys, mountains, buildings, and/or other structure which may interfere with data connectivity), etc.

As navigation data may also be limited at the same time by dark-spots, the system may estimate the route a distance ahead that is based on the largest dark-spot diameter/size in the current region to detect whether an impending dark-spot is on the route.

In each of the examples herein, the start/end locations of the dark-spot may be used in real-time to adjust the size of a streaming media content buffer for currently streaming media.

In an example, the navigation system may predict multiple possible routes to a current destination ahead based on current vehicle location and estimated, user-provided, and/or predicted destination data. The system may then identify dark-spots along each of the possible routes, and further may identify the closest dark-spots on each of a plurality of possible routes. Then, based on the location of the closest dark-spot, adjust buffer size based on a start location and end location of the closest dark-spot, and further based on a current rate of media content streaming, as well as previously stored user preferences.

In some examples, the system may estimate the duration of travel from a start location to an end location of a dark-spot, and based on said duration of travel, and further based on a current media content streaming rate, the system may estimate a buffer size needed to enable continuous media content streaming at the current media content streaming rate through the upcoming dark-spot. Further, the system may estimate a download time to fill the estimated buffer size based on current data rates. If the download time exceeds a time to arrival at a start location of a closest dark-spot, the system may request an increase data transmission rate before reaching the start location of the closest dark-spot to be able to fill the increased buffer size before entering the upcoming dark-spot and/or may prompt a user to accept a reduced media content streaming rate while traveling through said closest dark-spot.

Turning now to FIG. 1, it shows an example partial view of one type of environment for an infotainment system that dynamically adjusts a buffer size based on dark-spot locations, including an example partial view of one type of environment for an audio customization system. The system includes an interior of a cabin 100 of a vehicle 102 in which a driver and/or one or more passengers may be seated. Vehicle 102 of FIG. 1 may be a motor vehicle including drive wheels (not shown) and an internal combustion engine 104. Internal combustion engine 104 may include one or more combustion chambers which may receive intake air via an intake passage and exhaust combustion gases via an exhaust passage. Vehicle 102 may be a road automobile, among other types of vehicles. In some examples, vehicle 102 may include a hybrid propulsion system including an energy conversion device operable to absorb energy from vehicle motion and/or the engine and convert the absorbed energy to an energy form suitable for storage by an energy storage device. Vehicle 102 may include a fully electric vehicle, incorporating fuel cells, solar energy capturing elements, and/or other energy storage systems for powering the vehicle.

As shown, an instrument panel 106 may include various displays and controls accessible to a human driver (also referred to as the user) of vehicle 102. For example, instrument panel 106 may include a touch screen 108 of an in-vehicle computing system 109 (e.g., an infotainment system), an audio system control panel, and an instrument cluster 110. Touch screen 108 may receive user input to the in-vehicle computing system 109 for controlling audio output, visual display output, user preferences, control parameter selection, etc. While the example system shown in FIG. 1 includes audio system controls that may be performed via a user interface of in-vehicle computing system 109, such as touch screen 108 without a separate audio system control panel, in other embodiments, the vehicle may include an audio system control panel, which may include controls for a conventional vehicle audio system such as a radio, compact disc player, MP3 player, etc. The audio system controls may include features for controlling one or more aspects of audio output via speakers 112 of a vehicle speaker system. For example, the in-vehicle computing system or the audio system controls may control a volume of audio output, a distribution of sound among the individual speakers of the vehicle speaker system, an equalization of audio signals, and/or any other aspect of the audio output. In further examples, in-vehicle computing system 109 may adjust a radio station selection, a playlist selection, a source of audio input (e.g., from radio or CD or MP3), etc., based on user input received directly via touch screen 108, or based on data regarding the user (such as a physical state and/or environment of the user) received via external devices 150 and/or mobile device 128. The audio system of the vehicle may include an amplifier (not shown) coupled to plurality of loudspeakers (not shown). In some embodiments, one or more hardware elements of in-vehicle computing system 109, such as touch screen 108, a display screen 111, various control dials, knobs and buttons, memory, processor(s), and any interface elements (e.g., connectors or ports) may form an integrated head unit that is installed in instrument panel 106 of the vehicle. The head unit may be fixedly or removably attached in instrument panel 106. In additional or alternative embodiments, one or more hardware elements of the in-vehicle computing system 109 may be modular and may be installed in multiple locations of the vehicle. As used herein, a media output device may include one or more hardware devices configured to output streaming media content, such as an audio system, a visual display device etc. (e.g., touch screen 108, display screen 111, speakers 112).

The vehicle may include one or more sensors for monitoring the vehicle, the user, and/or the environment. For example, sensors may be positioned in a powertrain compartment, on an external surface of the vehicle, and/or in other suitable locations for providing information regarding the operation of the vehicle, ambient conditions of the vehicle, a user of the vehicle, etc. Information regarding ambient conditions of the vehicle, vehicle status, or vehicle driver may also be received from sensors external to/separate from the vehicle (that is, not part of the vehicle system), such as sensors coupled to external devices 150 and/or mobile device 128.

Cabin 100 may also include one or more user objects, such as mobile device 128, that are stored in the vehicle before, during, and/or after travelling. The mobile device 128 may include a smart phone, a tablet, a laptop computer, a portable media player, and/or any suitable mobile computing device. The mobile device 128 may be connected to the in-vehicle computing system via communication link 130. The communication link 130 may be wired (e.g., via Universal Serial Bus [USB], Mobile High-Definition Link [MHL], High-Definition Multimedia Interface [HDMI], Ethernet, etc.) or wireless (e.g., via BLUETOOTH, WIFI, WIFI direct, Near-Field Communication [NFC], cellular connectivity, etc.) and configured to provide two-way communication between the mobile device and the in-vehicle computing system. The mobile device 128 may include one or more wireless communication interfaces for connecting to one or more communication links (e.g., one or more of the example communication links described above). The wireless communication interface may include one or more physical devices, such as antenna(s) or port(s) coupled to data lines for carrying transmitted or received data, as well as one or more modules/drivers for operating the physical devices in accordance with other devices in the mobile device. For example, the communication link 130 may provide sensor and/or control signals from various vehicle systems (such as vehicle audio system, climate control system, etc.) and the touch screen 108 to the mobile device 128 and may provide control and/or display signals from the mobile device 128 to the in-vehicle systems and the touch screen 108. The communication link 130 may also provide power to the mobile device 128 from an in-vehicle power source in order to charge an internal battery of the mobile device.

In-vehicle computing system 109 may also be communicatively coupled to additional devices operated and/or accessed by the user but located external to vehicle 102, such as one or more external devices 150. In the depicted embodiment, external devices are located outside of vehicle 102 though it will be appreciated that in alternate embodiments, external devices may be located inside cabin 100. The external devices may include a server computing system, personal computing system, portable electronic device, electronic wrist band, electronic head band, portable music player, electronic activity tracking device, pedometer, smart-watch, GPS system, etc. External devices 150 may be connected to the in-vehicle computing system via communication link 136 which may be wired or wireless, as discussed with reference to communication link 130, and configured to provide two-way communication between the external devices and the in-vehicle computing system. For example, external devices 150 may include one or more sensors and communication link 136 may transmit sensor output from external devices 150 to in-vehicle computing system 109 and touch screen 108. External devices 150 may also store and/or receive information regarding contextual data, user behavior/preferences, operating rules, etc. and may transmit such information from the external devices 150 to in-vehicle computing system 109 and touch screen 108. As described herein, the communication link may be limited in some locations, referred to as dark-spots.

In-vehicle computing system 109 may analyze the input received from external devices 150, mobile device 128, and/or other input sources and select settings for various in-vehicle systems (such as the audio system), provide output via touch screen 108 and/or speakers 112, communicate with mobile device 128 and/or external devices 150, and/or perform other actions based on the assessment. In some embodiments, all or a portion of the assessment may be performed by the mobile device 128 and/or the external devices 150.

In some embodiments, one or more of the external devices 150 may be communicatively coupled to in-vehicle computing system 109 indirectly, via mobile device 128 and/or another of the external devices 150. For example, communication link 136 may communicatively couple external devices 150 to mobile device 128 such that output from external devices 150 is relayed to mobile device 128. Data received from external devices 150 may then be aggregated at mobile device 128 with data collected by mobile device 128, the aggregated data then transmitted to in-vehicle computing system 109 and touch screen 108 via communication link 130. Similar data aggregation may occur at a server system and then transmitted to in-vehicle computing system 109 and touch screen 108 via communication link 136/130.

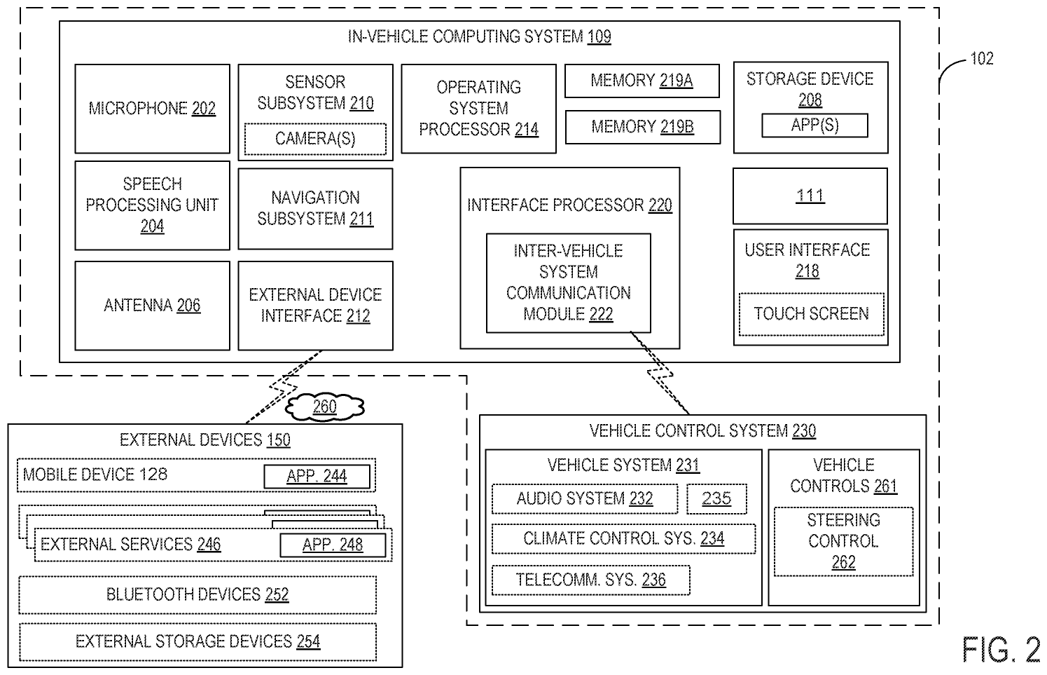

FIG. 2 shows a block diagram of an in-vehicle computing system 109 configured and/or integrated inside vehicle 102. In-vehicle computing system 109 may perform one or more of the methods described herein in some embodiments. In some examples, the in-vehicle computing system 109 may be a vehicle infotainment system configured to provide information-based media content (audio and/or visual media content, including entertainment content, navigational services, etc.) to a vehicle user to enhance the operator's in-vehicle experience. The vehicle infotainment system may include, or be coupled to, various vehicle systems, sub-systems, hardware components, as well as software applications and systems that are integrated in, or integratable into, vehicle 102 in order to enhance an in-vehicle experience for a driver and/or a passenger.

In-vehicle computing system 109 may include one or more processors including an operating system processor 214 and an interface processor 220. Operating system processor 214 may execute an operating system on the in-vehicle computing system, and control input/output, display, playback, and other operations of the in-vehicle computing system. Interface processor 220 may interface with a vehicle control system 230 via an inter-vehicle system communication module 222.

Inter-vehicle system communication module 222 may output data to other vehicle systems 231 and vehicle control elements 261, while also receiving data input from other vehicle components and systems 231, 261, e.g. by way of vehicle control system 230. When outputting data, inter-vehicle system communication module 222 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System [GPS] sensors, etc.), digital signals propagated through vehicle data networks (such as an engine CAN bus through which engine related information may be communicated, a climate control CAN bus through which climate control related information may be communicated, and a multimedia data network through which multimedia data is communicated between multimedia components in the vehicle). For example, the in-vehicle computing system 109 may retrieve from the engine CAN bus the current speed of the vehicle estimated by the wheel sensors, a power state of the vehicle via a battery and/or power distribution system of the vehicle, an ignition state of the vehicle, etc. In addition, other interfacing means such as Ethernet may be used as well without departing from the scope of this disclosure.

A non-volatile storage device 208 may be included in in-vehicle computing system 109 to store data such as instructions executable by processors 214 and 220 in non-volatile form. The storage device 208 may store application data, including prerecorded sounds, to enable the in-vehicle computing system 109 to run an application for connecting to a cloud-based server and/or collecting information for transmission to the cloud-based server. The application may retrieve information gathered by vehicle systems/sensors, input devices (e.g., user interface 218), data stored in volatile 219A or non-volatile storage device (e.g., memory) 219B, devices in communication with the in-vehicle computing system (e.g., a mobile device connected via a Bluetooth link), etc. In-vehicle computing system 109 may further include a volatile memory 219A. Volatile memory 219A may be random access memory (RAM). Non-transitory storage devices, such as non-volatile storage device 208 and/or non-volatile memory 219B, may store instructions and/or code that, when executed by a processor (e.g., operating system processor 214 and/or interface processor 220), controls the in-vehicle computing system 109 to perform one or more of the actions described in the disclosure.

A microphone 202 may be included in the in-vehicle computing system 109 to receive voice commands from a user, to measure ambient noise in the vehicle, to determine whether audio from speakers of the vehicle is tuned in accordance with an acoustic environment of the vehicle, etc. A speech processing unit 204 may process voice commands, such as the voice commands received from the microphone 202. In some embodiments, in-vehicle computing system 109 may also be able to receive voice commands and sample ambient vehicle noise using a microphone included in an audio system 232 of the vehicle.

One or more additional sensors may be included in a sensor subsystem 210 of the in-vehicle computing system 109. For example, the sensor subsystem 210 may include a camera, such as a rear view camera for assisting a user in parking the vehicle and/or a cabin camera for identifying a user (e.g., using facial recognition and/or user gestures). Sensor subsystem 210 of in-vehicle computing system 109 may communicate with and receive inputs from various vehicle sensors and may further receive user inputs. For example, the inputs received by sensor subsystem 210 may include transmission gear position, transmission clutch position, gas pedal input, brake input, transmission selector position, vehicle speed, engine speed, mass airflow through the engine, ambient temperature, intake air temperature, etc., as well as inputs from climate control system sensors (such as heat transfer fluid temperature, antifreeze temperature, fan speed, passenger compartment temperature, desired passenger compartment temperature, ambient humidity, etc.), an audio sensor detecting voice commands issued by a user, a fob sensor receiving commands from and optionally tracking the geographic location/proximity of a fob of the vehicle, etc. While certain vehicle system sensors may communicate with sensor subsystem 210 alone, other sensors may communicate with both sensor subsystem 210 and vehicle control system 230, or may communicate with sensor subsystem 210 indirectly via vehicle control system 230. A navigation subsystem 211 of in-vehicle computing system 109 may generate and/or receive navigation information such as location information (e.g., via a GPS sensor and/or other sensors from sensor subsystem 210), route guidance, traffic information, point-of-interest (POI) identification, and/or provide other navigational services for the driver.

External device interface 212 of in-vehicle computing system 109 may be coupleable to and/or communicate with one or more external devices 150 located external to vehicle 102. While the external devices are illustrated as being located external to vehicle 102, it is to be understood that they may be temporarily housed in vehicle 102, such as when the user is operating the external devices while operating vehicle 102. In other words, the external devices 150 are not integral to vehicle 102. The external devices 150 may include a mobile device 128 (e.g., connected via a Bluetooth, NFC, WIFI direct, or other wireless connection) or an alternate Bluetooth-enabled device 252. Mobile device 128 may be a mobile phone, smart phone, wearable devices/sensors that may communicate with the in-vehicle computing system via wired and/or wireless communication, or other portable electronic device(s). Other external devices include external services 246. For example, the external devices may include extra-vehicular devices that are separate from and located externally to the vehicle. Still other external devices include external storage devices 254, such as solid-state drives, pen drives, USB drives, etc. External devices 150 may communicate with in-vehicle computing system 109 either wirelessly or via connectors without departing from the scope of this disclosure. For example, external devices 150 may communicate with in-vehicle computing system 109 through the external device interface 212 over network 260, a universal serial bus (USB) connection, a direct wired connection, a direct wireless connection, and/or other communication link.

The external device interface 212 may provide a communication interface to enable the in-vehicle computing system to communicate with mobile devices associated with contacts of the driver. For example, the external device interface 212 may enable phone calls to be established and/or text messages (e.g., SMS, MMS, etc.) to be sent (e.g., via a cellular communications network) to a mobile device associated with a contact of the driver. The external device interface 212 may additionally or alternatively provide a wireless communication interface to enable the in-vehicle computing system to synchronize data with one or more devices in the vehicle (e.g., the driver's mobile device) via WIFI direct, as described in more detail below.

One or more applications 244 may be operable on mobile device 128. As an example, mobile device application 244 may be operated to aggregate user data regarding interactions of the user with the mobile device. For example, mobile device application 244 may aggregate data regarding music playlists listened to by the user on the mobile device, telephone call logs (including a frequency and duration of telephone calls accepted by the user), positional information including locations frequented by the user and an amount of time spent at each location, etc. The collected data may be transferred by application 244 to external device interface 212 over network 260. In addition, specific user data requests may be received at mobile device 128 from in-vehicle computing system 109 via the external device interface 212. The specific data requests may include requests for determining where the user is geographically located, an ambient noise level and/or music genre at the user's location, an ambient weather condition (temperature, humidity, etc.) at the user's location, etc. Mobile device application 244 may send control instructions to components (e.g., microphone, amplifier etc.) or other applications (e.g., navigational applications) of mobile device 128 to enable the requested data to be collected on the mobile device or requested adjustment made to the components. Mobile device application 244 may then relay the collected information back to in-vehicle computing system 109.

Likewise, one or more applications 248 may be operable on external services 246. As an example, external services applications 248 may be operated to aggregate and/or analyze data from multiple data sources. For example, external services applications 248 may aggregate data from one or more social media accounts of the user, data from the in-vehicle computing system (e.g., sensor data, log files, user input, etc.), data from an internet query (e.g., weather data, POI data), etc. The collected data may be transmitted to another device and/or analyzed by the application to determine a context of the driver, vehicle, and environment and perform an action based on the context (e.g., requesting/sending data to other devices).

Vehicle control system 230 may include controls for controlling aspects of various vehicle systems 231 involved in different in-vehicle functions. These may include, for example, controlling aspects of vehicle audio system 232 for providing audio entertainment to the vehicle occupants, aspects of climate control system 234 for meeting the cabin cooling or heating needs of the vehicle occupants, as well as aspects of telecommunication system 236 for enabling vehicle occupants to establish telecommunication linkage with others.

Audio system 232 may include one or more acoustic reproduction devices including electromagnetic transducers such as speakers 235. Vehicle audio system 232 may be passive or active such as by including a power amplifier. In some examples, in-vehicle computing system 109 may be the only audio source for the acoustic reproduction device or there may be other audio sources that are connected to the audio reproduction system (e.g., external devices such as a mobile phone). The connection of any such external devices to the audio reproduction device may be analog, digital, or any combination of analog and digital technologies.

Climate control system 234 may be configured to provide a comfortable environment within the cabin or passenger compartment of vehicle 102. Climate control system 234 includes components enabling controlled ventilation such as air vents, a heater, an air conditioner, an integrated heater and air-conditioner system, etc. Other components linked to the heating and air-conditioning setup may include a windshield defrosting and defogging system capable of clearing the windshield and a ventilation-air filter for cleaning outside air that enters the passenger compartment through a fresh-air inlet.

Vehicle control system 230 may also include controls for adjusting the settings of various vehicle controls 261 (or vehicle system control elements) related to the engine and/or auxiliary elements within a cabin of the vehicle, such as steering wheel controls 262 (e.g., steering wheel-mounted audio system controls, cruise controls, windshield wiper controls, headlight controls, turn signal controls, etc.), instrument panel controls, microphone(s), accelerator/brake/clutch pedals, a gear shift, door/window controls positioned in a driver or passenger door, seat controls, cabin light controls, audio system controls, cabin temperature controls, etc. Vehicle controls 261 may also include internal engine and vehicle operation controls (e.g., engine controller module, actuators, valves, etc.) that are configured to receive instructions via the CAN bus of the vehicle to change operation of one or more of the engine, exhaust system, transmission, and/or other vehicle system. The control signals may also control audio output at one or more speakers 235 of the vehicle's audio system 232. For example, the control signals may adjust audio output characteristics such as volume, equalization, audio image (e.g., the configuration of the audio signals to produce audio output that appears to a user to originate from one or more defined locations), audio distribution among a plurality of speakers, etc. Likewise, the control signals may control vents, air conditioner, and/or heater of climate control system 234. For example, the control signals may increase delivery of cooled air to a specific section of the cabin.

Control elements positioned on an outside of a vehicle (e.g., controls for a security system) may also be connected to computing system 109, such as via communication module 222. The control elements of the vehicle control system may be physically and permanently positioned on and/or in the vehicle for receiving user input. In addition to receiving control instructions from in-vehicle computing system 109, vehicle control system 230 may also receive input from one or more external devices 150 operated by the user, such as from mobile device 128. This allows aspects of vehicle systems 231 and vehicle controls 261 to be controlled based on user input received from the external devices 150.

In-vehicle computing system 109 may further include an antenna 206. Antenna 206 is shown as a single antenna, but may comprise one or more antennas in some embodiments. The in-vehicle computing system may obtain broadband wireless internet access via antenna 206, and may further receive broadcast signals such as radio, television, weather, traffic, and the like. The in-vehicle computing system may receive positioning signals such as GPS signals via one or more antennas 206. The in-vehicle computing system may also receive wireless commands via FR such as via antenna(s) 206 or via infrared or other means through appropriate receiving devices. In some embodiments, antenna 206 may be included as part of audio system 232 or telecommunication system 236. Additionally, antenna 206 may provide AM/FM radio signals to external devices 150 (such as to mobile device 128) via external device interface 212.

One or more elements of the in-vehicle computing system 109 may be controlled by a user via user interface 218. User interface 218 may include a graphical user interface presented on a touch screen, such as touch screen 108 of FIG. 1, and/or user-actuated buttons, switches, knobs, dials, sliders, etc. For example, user-actuated elements may include steering wheel controls, door and/or window controls, instrument panel controls, audio system settings, climate control system settings, and the like. A user may also interact with one or more applications of the in-vehicle computing system 109 and mobile device 128 via user interface 218. In addition to receiving a user's vehicle setting preferences on user interface 218, vehicle settings selected by in-vehicle control system may be displayed to a user on user interface 218. Notifications and other messages (e.g., received messages), as well as navigational assistance, may be displayed to the user on a display of the user interface. User preferences/information and/or responses to presented messages may be performed via user input to the user interface.

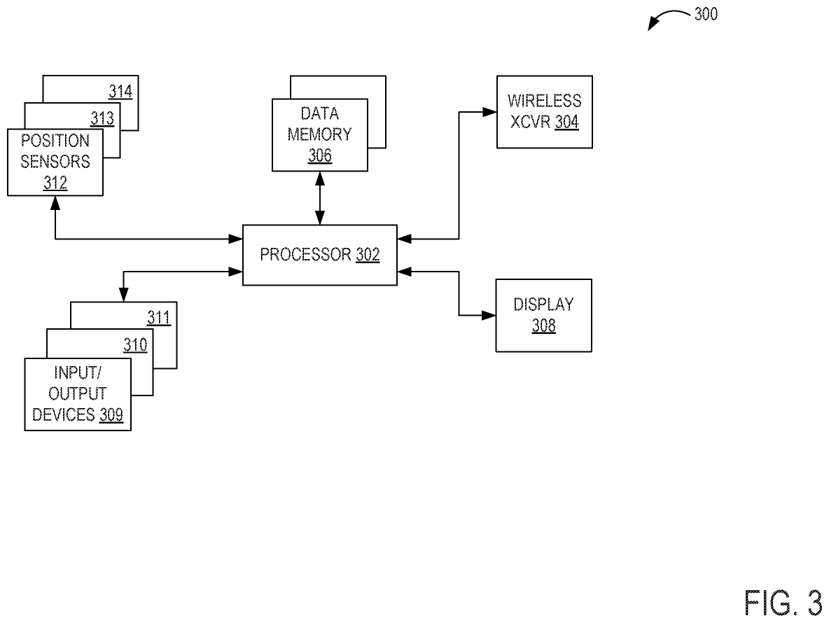

FIG. 3 is a block diagram illustration of an example navigation system 300 that caches navigation content associated with wireless (e.g., cellular) dark-spots. The system includes a processor 302, a cellular transceiver 304, memory, including map data memory 306, a display 308, a plurality of input/output devices 309-311 and a plurality of sensors 312-314. The navigation system may be configured for example as a handheld device, as a component of a motor vehicle navigation system (e.g., in-vehicle computing system 109 of FIG. 2), as a component of a smartphone, and/or as any other suitable computing device(s).

The cellular transceiver 304 (also referred to as wireless transceiver) may include a transmitter and a receiver and is generally capable of transmitting and receiving wireless signals, for example. The transmission and the reception may be done on the same frequency or on different frequencies, depending on the type of transceiver used. The transceiver 304 may send and receive signals from the processor 302. As such, the transceiver 304 may receive wireless data including wireless dark-spot data (e.g., locations/boundaries of wireless dark-spots, wireless network coverage parameters within a wireless dark-spot, etc.), etc. from a remote service, such as a cloud storage device located remotely from the navigation system and/or remotely from the device (e.g., the smartphone, handheld device, in-vehicle computing system, etc.) that includes the navigation system. In some examples the wireless transceiver 304 may receive route and/or dark-spot data (areas with no cellular data coverage, for example) information from a navigation data server. Upon receiving the wireless data, the transceiver 304 may send the received data to the processor 302, for processing and storing.

Methods of operation of the system of FIG. 3 are described herein, including with regard to FIG. 4.

Position sensors 312-314 may measure a current position and/or location of the navigation system and relay the position information to the processor 302. Some examples of position sensors include capacitive transducer, capacitive displacement sensor, eddy-current sensor, GPS receiver, accelerometer, etc. The current location of the navigation system may be determined based on the output of the position sensors 312-314, for example. The position sensors 312-314 may additionally or alternatively, receive position information from the processor 302. As such, the processor 302 may communicate bi-directionally with the position sensors 312-314. The processor 302 receives further input via input/output devices 309-311. Some examples of input devices may include keyboard, touch pad, joysticks, microphones, etc., and examples of output devices may include monitor, printer, etc. For example, a user may input a destination using the touch pad of device 309 overlaid on display device 308, and the display device 308 may display several options for selection on the monitor, for example.

The processor 302 may receive a current location from the position sensors 312-314, receive wireless dark-spot data information from the wireless transceiver 304 and/or from on-board memory, receive a destination input from the user using plurality of input/output devices 309-311, and may generate route data, which is then stored in the data memory 306. As such, the data may include dark-spot data. Furthermore, the data may include a map of the route generated, for example. In some examples, the route may be displayed on the display 308 (e.g., including a touchscreen, monitor, etc.). In situations when there is no cellular coverage, the processor 302 may retrieve the map from the map data memory 306. The processor 302 may further cache the processed map along with the additional data relating to the dark-spots in the data, and carry out the methods described herein, such as with regard to FIGS. 4-5 with the system of FIG. 6.

FIG. 4 shows an example method 400, which may be executed by an in-vehicle computing system/infotainment system to predict upcoming dark-spots and dynamically adjust a streaming media buffer size accordingly. The method of FIG. 4 may be incorporated into and may cooperate with the system of FIGS. 1-3. Further, at least a portion of the method of FIG. 4 may be incorporated as executable instructions stored in non-transitory memory, while other portions of the method may be performed via a controller transforming operating states of devices and actuators in the physical world.

Method 400 begins at operation 402, wherein the in-vehicle computing system estimates vehicle operating conditions. In one example, vehicle operating conditions may include a current vehicle location, a current vehicle speed, a current rate of media content streaming via an infotainment system of the vehicle, one or more engine operating conditions, one or more motor operating conditions, and/or one or more route conditions, including traffic, weather, etc.

At operation 404, the in-vehicle computing system forecasts the vehicle's route at a distance greater than the largest estimated dark-spot size. In one example, a user may input a route to a destination into a navigation subsystem of the vehicle, and the in-vehicle computing system may forecast a route of travel based on the input destination. In another example, the in-vehicle computing system may infer a route of travel based on vehicle operating conditions determined at operation 402, and further based on vehicle operating history (e.g., previously traveled routes). In one example, the in-vehicle computing system may implement or access a neural network trained to forecast a current route of the vehicle based on a plurality of factors, including one or more of vehicle operating history, vehicle operating conditions, a currently selected driver profile, weather conditions, time of day, date, day of the week, etc. In another example, the in-vehicle computing system may forecast a plurality of potential routes to a destination. In some examples, forecasting a route includes determining a route of travel to a destination, wherein the destination may be input by a user/driver or inferred based on the above said factors. In some examples, forecasting a route includes determining one or more features of a route, including speed limit, traffic conditions, road conditions (e.g., grade, highway or city, etc.), Internet connectivity/bandwidth along the route (e.g., expected Internet/cellular connectivity to one or more networks and/or media content providers). The in-vehicle computing system may forecast the vehicle's route by accessing one or more off-board systems, such as a destination provider, navigation services (e.g., a global positioning system), or through vehicle-to-vehicle communication (e.g., by communicating with one or more vehicle's within a threshold radius of the vehicle. In one example, the in-vehicle computing system may query a dark-spot repository for sizes of dark spots within a threshold radius of a current location of the vehicle, and upon determining a largest sized dark-spot (that is, a dark-spot with an anticipated longest data communication degradation incurred by passing therethrough) within the threshold radius of the current vehicle location, may forecast at least a distance greater than the size of the largest sized dark-spot ahead along a current route. By forecasting at least a distance greater than the size of the largest sized dark spot ahead along a current route, the in-vehicle computing system may be able to estimate an expected duration/time of travel between the start location of the dark spot and the end location of the dark spot along the current forecast route. Said another way, the in-vehicle computing system, by forecasting at least a distance greater than the size of the largest sized dark spot ahead along a current route, may be able to assess route conditions through an entirety of an impending dark-spot, before entering said dark spot, wherein data communication may be degraded. In some examples, operation 404 includes forecasting a plurality of potential routes to one or more potential destinations. A plurality of routes may be forecast when no destination has been set (e.g., a user has not entered a destination into a navigation system) or when a route to a destination is unknown or uncertain. In some examples, a plurality of routes may be forecast even when a destination has been set, to enable greater flexibility and responsiveness in the event of a detour or unexpected change of destination.

At operation 406, the in-vehicle computing system determines the start location and end location of a closest dark-spot along the forecast route. In one example, the in-vehicle computing system may query a dark-spot repository using a current forecast route of travel, wherein the dark-spot repository may store one or more dark-spot entries indexed by route and/or location. The dark-spot repository may, in response to said query, return to the in-vehicle computing system a list of upcoming dark-spots along a current route. The in-vehicle computing system may then evaluate the list of upcoming dark-spots to determine a closest, or next-to-be-encountered, dark-spot along the current forecast route of travel. Each dark-spot entry returned to the in-vehicle computing system may be uniquely associated with a dark-spot along a current route of travel, and may include one or more features for said dark-spot, including one or more of a center location of the dark-spot, a radius of the dark spot, one or more points of intersection between a boundary of said dark-spot and one or more routes of travel passing therethrough. In some examples, the dark-spot repository may return to the in-vehicle computing system a start location of each dark spot along a current forecast route and an end location of each dark spot along the current forecast route. In other examples, the in-vehicle computing system may correlate data obtained from the dark-spot repository with information regarding a currently forecast route, to determine a start location and an end location of a next dark-spot. In examples where a plurality of routes are forecast at operation 404, operation 406 may include determining for each of the plurality of forecast routes, a corresponding plurality of closest dark-spots, according to one or more of the examples given above. In some examples, when a plurality of routes are forecast, a closest dark-spot along a most probable route of travel may be used in the remainder of operations of method 400. In some examples, when a plurality of routes are forecast, a largest dark-spot may be used in the reminder of operations of method 400 (that is, a largest dark-spot without any interceding dark-spots along a route connecting a current location of the vehicle and a closest boundary point of said largest dark-spot).

At operation 408, the in-vehicle computing system determines a time of arrival at the start location of the next dark-spot based on the current vehicle location, vehicle speed, traffic conditions, and/or estimated route speeds. In one example, the in-vehicle computing system determines a baseline time to reach a start location of the closest dark spot based on speed limits along the currently forecast route between the current vehicle location and the start location of the closest dark spot, and adjusts the baseline time to produce an estimated time of arrival based on average vehicle speed, traffic conditions and weather conditions along the route between the current location of the vehicle and the start location of the closet dark-spot.

At operation 410, the in-vehicle computing system estimates the duration to be spent traveling through the closest dark-spot based on vehicle speed and traffic conditions along the currently forecast route through the dark-spot, and further based on the estimated time of arrival. In one example, the in-vehicle computing system determines a baseline duration for traversing the closest dark-spot (that is, moving from a start location of the dark-spot to an end location of the dark-spot along the forecast route) based on speed limits along the currently forecast route between the start location and the end location of the closest dark-spot, and adjusts the baseline duration based on average vehicle speed, weather, and traffic conditions along the route between the start location of the closest dark-spot and the end location of the closet dark-spot. In some examples, the duration spent traveling through the closest dark-spot may be further estimated based on the time of arrival determined at operation 408. As an example, based on historical traffic data indexed according to time of day, the baseline duration of passing from the start location to the end location of the next closest dark-spot may be updated (e.g., by multiplying the baseline duration by an adjustment factor determined based on a relative degree of traffic at the time of arrival at the start location of the dark-spot) based on historical traffic conditions along the forecast route between the start location of the next closest dark spot and the end location of the next closest dark spot at the estimated time of arrival. This may enable the in-vehicle computing system to better account for cyclic or predictable traffic fluctuations along the route, such as rush-hour traffic, school zones, etc. In one example, estimating the duration of travel from the start location to the end location of the upcoming dark-spot is based on traffic conditions along the current route between the start location and the end location, a distance between the start location and end location, and further based on vehicle speed of the vehicle.

At operation 412, the in-vehicle computing system estimates an updated buffer size to account for the upcoming data communication degradation within the closest dark spot. The in-vehicle computing system may determine an updated streaming media content buffer size based on an expected rate of media content streaming through the closest dark-spot via an infotainment system of the vehicle, the duration of time to traverse between the start location of the closest dark-spot and the end location of the closest-dark spot (determined at operation 410), and further based on an expected bandwidth/download rate within the upcoming dark-spot. In one example, an updated buffer size for a streaming media content buffer may be estimated based on the following equation:

B=(Rₛ−R_{D})D+T

Where B is the adjusted buffer size, R_{S} is the estimated average rate of media content streaming within the closest dark-spot, R_{D} is the estimated average rate of media content download/bandwidth within the closest dark-spot (e.g., R_{D} may be 0 in an area with no data connectivity), D is the expected duration to travel from the start location to the end location of the closest dark-spot, and T is a threshold buffer capacity, which may be set by a user, learned based on vehicle operating history, or set to a pre-determined threshold. In some examples, a user may have previously selected not to dynamically adjust buffer sized based on upcoming data communication degradations, in which case the in-vehicle computing system may proceed to and through an upcoming data communication degradation (dark-spot) without altering buffer size, or with an attenuated adjustment of buffer size.

At operation 414, the in-vehicle computing system estimates download duration/time to fill the adjusted buffer size based on average expected data bandwidth between the current vehicle location and the start location of the closest dark-spot. In one example, the time to fill the adjusted buffer size may be given by the following equation:

$${T}_{D} = \frac{B}{{R}_{D o} - {R}_{S o}}$$

Where T_{D} is the estimated download time, B is the adjusted buffer size determined at operation 412, R_{Do} is the average download rate/bandwidth along the current forecast route between the current location of the vehicle and the start location of the closest dark spot and R_{So} is the average media content streaming rate estimated along the current route between the current location of the vehicle and the start location of the closest dark-spot.

At operation 416, the in-vehicle computing system determines whether there is sufficient time to fill the adjusted buffer size (B) prior to reaching the start location of the closest dark-spot (that is, prior to the arrival time of the vehicle at the start location of the dark-spot), and if not, requests an increased data transmission rate from a streaming content provider. In one example, at operation 416, if the in-vehicle computing system determines that the download duration/time (determined at operation 414) is greater than a duration of time until the vehicle reaches the starting location of the closest dark-spot (that is, if there is insufficient time until the arrival time to complete filling of the adjusted buffer), the in-vehicle computing system may request an increased data transmission rate from a streaming media content provider and/or adjust one or more streaming media parameters, such as stream quality, stream frequency, encoding type, etc. In some examples, stream parameter adjustment may occur based on pre-determined user preferences. In one example, a user may have previously elected to accept reduced streaming media content fidelity while traversing dark-spots, instead of electing to increase data transmission rates in-case of insufficient time for filling an adjusted buffer size prior to entering an upcoming region of data communication degradation.

At operation 418, the in-vehicle computing system fills the adjusted buffer size prior to reaching the start location of the closest dark spot, and while traversing the dark-spot, plays media content stored in the adjusted size media content buffer via one or more media output devices, to satisfy a user's media streaming request. In one example, the in-vehicle computing system initiates filling of the adjusted size media content buffer at a time greater than or equal to the estimated download duration/time prior to the estimated arrival time, thereby enabling the adjusted size media content buffer to be filled prior to entering the closest dark-spot.

At operation 420, once through the closest dark-spot, the in-vehicle computing system determines whether the adjusted buffer size was sufficient to meet a user's media streaming request. In other words, at operation 420, the in-vehicle computer may determine whether the adjusted buffer size was within a threshold of the user requested media content, requested while traversing the dark-spot. Further, at operation 420, the in-vehicle computing system updates the dark-spot repository with an actual start location, an actual start time, an actual end location, an actual end time, and an actual duration of time spent traveling through the dark-spot. In other words, the in-vehicle computing system, once through the dark-spot, further refines the prediction accuracy of the dark-spot repository by updating the dark-spot repository with feedback on actual conditions encountered prior to and within the dark-spot, such as actual data communication degradation (e.g., the actual available bandwidth within the dark-spot, R_{D}), actual size of the dark-spot, along with updated values for arrival time, traversal time (D in the equation above), etc. In one example, the dark-spot repository may employ the feedback provided by the in-vehicle computing system to perform on-line training of one or more predictive models and/or to update a dark-spot entry stored on the dark-spot repository, which may be utilized during a subsequent query of the dark-spot repository. In some examples, at operation 420, the in-vehicle computing system may, instead of, or in addition to, sending feedback to the dark-spot repository, directly transmit information regarding the latest encountered dark spot to one or more vehicles within a threshold radius via a vehicle-to-vehicle communication system.

In this way, method 400 enables an in-vehicle computing system, such as an infotainment system, to take into account areas with patchy or no internet connectivity, when there may be a disruption of services which are being run from the cloud. These services include, but are not limited to, online music, podcasts, navigational directions, video (in geographies where it's permitted etc.). Timely buffer management may be based on dark-spot knowledge to enable a seamless streaming experience for the consumer.

Turning to FIG. 5, a communication diagram 500, illustrating communications which may occur between an intelligent reasoning agent (iRA) 502, a destination provider 504, navigation services 506, a dark-spot repository 508, a content provider 510, and a vehicle infotainment system 512, during execution of a method, such as method 400, for predicting dark-spots and dynamically adjusting a buffer size for streaming media content based on the predicted dark-spots.

iRA 502 may be implemented by an in-vehicle computing system executing machine readable instructions stored on non-transitory memory. iRA 502 may be configured to receive input from various vehicle sensors of a vehicle, to assess current vehicle operating conditions, including current streaming of cloud based content via an infotainment system of a vehicle. As shown by arrow 514 in communication diagram 500, iRA 502 may query destination provider 504 for a current destination of the vehicle. In response, destination provider 504 may return to iRA 502 a current destination, as indicated by arrow 516. In some examples, destination provider 504 may be integrated into the in-vehicle computing system. In some examples, destination provider 504 may be an off-board system, that is, remotely located from the vehicle and in communication with iRA 502 via an external device interface. In some examples, the destination provider may comprise a statistical model, configured to predict one or more probable destinations based on one or more vehicle operating conditions and/or other contextual features. In such examples, iRA 502 may query destination provider 504 by providing one or more relevant vehicle operating conditions, wherein destination provider 504 may use the one or more relevant vehicle operating conditions as input into a statistical destination prediction model. In some examples, destination provider 504 returns to iRA 502 a list of a plurality of possible destinations, wherein in some examples the list may include a probability ranking of each of the plurality of possible destinations. In yet other examples, destination provider 504 may be configured to receive input from a user/operator of the vehicle, wherein said input may comprise a desired destination of the operator.

iRA 502, after receiving one or more destinations from destination provider 504, may query navigation services 506 with the one or more destinations, as indicated by arrow 518. In some examples, navigation services 506 may be a navigation subsystem built into the vehicle. In another example, navigation services 506 may be a third-party navigation application, such as Google Maps, Waze, etc. communicatively coupled to iRA 502. In response to the route query transmitted by iRA 502 at arrow 518, navigation services 506 may return one or more routes to one or more destinations included in the query, as indicated by arrow 520. In some examples, route information transmitted by navigation services 506 to iRA 502 may include one or more of traffic, weather, road conditions, construction locations, etc. along the route.

After receiving the one or more routes along with corresponding route information for the one or more routes, iRA 502 may query dark-spot repository 508 to obtain dark spot start locations and stop locations, as well as start times and stops times for one or more dark-spots along each of the one or more routes obtained from navigation services 506, as indicated by arrow 522. The dark-spot repository 508 may store one or more dark-spot entries indexed by route, location, and/or time. The dark-spot repository 508 may, in response to said query from iRA 502, return to the in-vehicle computing system a list of upcoming dark-spots along a current route, including one or more of start locations and stop locations for each upcoming dark-spot, and predicted/estimated times of arrival at, and durations of traversal through, said one or more upcoming dark-spots along a queried route, as indicated by arrow 524. Each dark-spot entry returned to iRA 502 may be uniquely associated with a dark-spot along the current route of travel, and may include one or more features for said dark-spot, including one or more of a center location of the dark-spot, a radius of the dark spot, one or more points of intersection between a boundary of said dark-spot and one or more routes of travel passing therethrough, an expected available connection strength/bandwidth within the dark-spot etc.

As discussed in more detail above with respect to FIG. 4, upon receiving information pertaining to the one or more upcoming dark-spots from dark-spot repository 508, iRA 502 may determine an adjusted buffer size, and an expected download duration to fill said adjusted buffer size, and may further determine an initiation time at which to trigger filling of said adjusted buffer size prior to entering a closest upcoming dark-spot, such that the buffer is filled prior to the arrival time at the start location of the closest dark-spot. In one example, the initiation time may be greater than an estimated download duration before the arrival time, such that download of the potentially increased buffer size may be accomplished prior to the arrival time. Upon reaching said initiation time, iRA 502 may transmit to an off-board content provider 510 a request for escalated buffering, as indicated by arrow 526 of communication diagram 500. In response to the escalated buffering request, the off-board content provider 510, the adjusted size buffer on-board the vehicle may begin to be filled, as indicated by arrow 528.

FIG. 6 shows an example system 600, comprising an intelligent reasoning agent (iRA) 602 communicatively coupled to a destination provider 604, navigation services 606, a dark-spot repository 608 and a content provider 610. The content provider 610 is in turn communicatively coupled to an infotainment system 612. The iRA 602 may or may not be communicatively coupled directly to infotainment system 612. System 600 may execute one or more of the methods described herein. For example, system 600 may perform one or more of the communication steps illustrated in communication diagram 500, as part of a method of dynamic buffer adjustment, such as method 400. iRA 602 assists in orchestrating dynamic buffering adjustments for media content streamed by the infotainment system 612 from the content provider 610, based on predicted internet dark-spots along a route of travel or inferred route of travel. In this example, iRA 602 is responsible for exchanging information across other components and predicts the internet connection availability along the current route, as described herein.

FIG. 6 also shows a destination provider 604 that provides the destination for the user, such as the navigation system described herein. In one example, a user may input a destination into a user interface of infotainment system 612, and infotainment system 612 may communicate the input destination to a destination provider 604, and/or directly to iRA 602. In some examples, a destination may be inferred based on data stored in a mobile device of a user, e.g., from a calendar entry for a next meeting in the mobile device described herein. The navigation services 606 provide the route for the user from a current location to the destination as described herein. In absence of a route, the iRA 602 may also predict one or more likely routes based on vehicle operating conditions, and contextual information such as time of the day, day of the week, current location, etc.

The Internet dark-spots repository 608 may include data learned from past vehicle operation, and/or may be provided via a cloud server as noted herein, and/or may include crowd sourced information that maps various coordinates as to locations where there are internet dark-spots. The dark-spots may be due to one or more of the following:

1. Unavailability of internet connections due to towers unavailability, tunnels, urban canyons & defense systems;

2. Heavy connection load on the same internet source; and

3. Reduced connectivity due to less than a non-zero threshold of communication bandwidth.

Crowd sourcing may be supported inside iRA 602, where the intelligent agent monitors data connection quality on a regular basis and updates dark-spot information in the dark-spot repository 608. The content provider 610 provides various streaming content like Music, Navigation, Video, Podcasts etc. to the infotainment system 612, such as described in FIGS. 1-3. The infotainment system 612 may include media output devices, with Audio & Video output capabilities. The infotainment system 612 may perform various functions, including streaming music, displaying a current route to a destination, enabling hands-free calling, as well as providing a user interface for controlling one or more parameters of vehicle operating.

FIG. 7 schematically shows example routes 702, 704, and 706, with starting locations by subscript a and engine locations with subscript b.

As an example, a vehicle may be starting a 704a and traveling route 704, where there is sufficient data coverage at a sufficiently fast level to provide desired streaming, such as music streaming from an off-board server source. As the vehicle travels toward 704b along the route 704, the system carries out one or more of the methods described herein, including identifying the next upcoming known dark-spot. The system may look-ahead a threshold distance for dark-spots in some examples rather than, or in addition to, identifying the next upcoming dark-spot. In some examples, the system may look-ahead a distance greater than the maximum expected time it would take to fill a buffer increased to the maximum allowed buffer size, which may be represented by the radius of dashed circle 714.

As the vehicle travels along route 704, at location 712 the vehicle may identify that upcoming dark-spot 720 is the next upcoming dark-spot with start/end locations 720a and 720b and having an estimated time in the dark-spot based on the estimated speed (e.g., current vehicle speed or speed of other vehicles entering/exiting the dark-spot (and/or based on duration other vehicle spent within the dark-spot 720). From this, the system may then determine a desired buffer size (e.g., buffer size increase) to enable streaming of currently played media through the dark-spot un-interrupted as described herein.

As the vehicle continues along route 704, data communication rates may drop requiring projecting out a larger radius (732) looking for potential dark-spots along possible routes, which here may include route 706. At location 730, the system identifies possible dark-spots 740 and 742 and thus identifies the desired buffer for each and selects the largest of the two to begin filling before reaching either spot.

Another vehicle, or the above vehicle at another time, may be traveling along route 702 starting at 702a. Here, the vehicle may encounter the same dark-spot 720 and thus may utilize its previous experience and/or the experience of another vehicle traveling through the same dark-spot yet on another route. While the route lengths may be different, information may still be relevant as if the dark-spot increased in size recently along route 704/6, the system may estimate an increased size of the dark-spot along route 702.

Note dark-spots may be learned/crowdsource not just from vehicles, but from even bicycles and/or pedestrian traffic along adjacent or near-by routes also passing through the same dark-spot, such as pedestrian route 750.

In one example, the IRA assistant may be a voice assistant and can interact with vehicle occupants to determine a destination that may be used for identifying potential dark-spots along the route. The voice assistant may also trigger content provided in the cloud for the escalated buffer.

In some examples, the method for buffer management may utilize start/end locations, find the time of arrival given current traffic conditions, estimate time in dark-spot, estimate buffer size needed, estimate time to load increased buffer based on current bandwidth, and estimate size of buffer, and then get that contact before entering, for each dark-spot.

In some examples, buffer management may be something different than just changing the size of the buffer. For example, buffer frequency and size of buffer may be adjusted together. Likewise, quality of stream may be adjusted with or without changing buffer size, based on estimated dark-spots, to enable continuous streaming through the dark-spot (e.g., by reducing the quality of the data buffered so that a longer duration in real time is stored). For example, in one approach a same size buffer is used with a change in quality of stream, fidelity, and/or degree of compression of data stored in the buffer being adjusted before entering the dark-spot, as playback systems can automatically switch quality level at different parts of the buffer during playback of the media.

The disclosure also provides support for a method for managing streaming media content in a vehicle, comprising: buffering streaming media content from a content provider in a data buffer in the vehicle, the buffer adjusted based on an upcoming data communication degradation, and playing the buffered media content during an interrupted communication with the content provider. In a first example of the method, the upcoming data communication degradation is defined by a start location and an end location of data communication degradation. In a second example of the method, optionally including the first example, the start location and end location are used to generate an estimated time of arrival at the start location and a time duration for passing from the start location to the end location of the upcoming data communication degradation. In a third example of the method, optionally including one or both of the first and second examples, a buffer size is adjusted based on one or more of the estimated time of arrival and the time duration for passing through the upcoming data communication degradation. In a fourth example of the method, optionally including one or more or each of the first through third examples, the upcoming data communication degradation is defined by a start time and an end time of data communication degradation. In a fifth example of the method, optionally including one or more or each of the first through fourth examples, an increased buffer size is filled before the start time of data communication degradation. In a sixth example of the method, optionally including one or more or each of the first through fifth examples, the method further comprises, suggesting an encoding technique to a user based on the start time and the end time of data communication degradation. In a seventh example of the method, optionally including one or more or each of the first through sixth examples, after passing through the data communication degradation, one or more of an actual start time and an actual end time are provided to an off-board system. In a eighth example of the method, optionally including one or more or each of the first through seventh examples, a plurality of possible routes are predicted and a longest data communication degradation is determined based on data for each of the plurality of possible routes. In a ninth example of the method, optionally including one or more or each of the first through eighth examples, a buffer size is determined based on the longest data communication degradation. In a tenth example of the method, optionally including one or more or each of the first through ninth examples, a buffer size is determined based on one or more of a current media content streaming rate, encoding technique, and quality of stream. In a eleventh example of the method, optionally including one or more or each of the first through tenth examples, the method further comprising: notifying a user that the streaming media is currently using escalated buffering while passing through data communication degradations.

The disclosure also provides support for an in-vehicle infotainment system, comprising, an external device interface communicatively coupling the in-vehicle infotainment system with one or more off-board systems, a media output device communicatively coupled to the external device interface, and a controller with computer-readable instructions stored on non-transitory memory thereof that when executed cause the controller to: predict an upcoming data communication degradation based on data received from an off-board system by the external device interface, wherein the upcoming data communication degradation is defined by a start location and an end location of an upcoming data communication degradation, determine a time of arrival at the start location and a time duration for passing from the start location to the end location, adjust dynamically a buffer size of a buffer of streaming media content being played by the media output device based on the time duration for passing from the start location to the end location, fill the buffer prior to the time of arrival at the start location of the data communication degradation, and play, via the media output device, contents of the buffer while passing from the start location to the end location of the data communication degradation. In a first example of the system, the external device comprises a dark-spot repository, and wherein the dark-spot repository stores a plurality of internet dark-spots indexed by location. In a second example of the system, optionally including the first example, the system further comprises: a navigation subsystem, and wherein the controller predicts the upcoming data communication degradation by querying the dark-spot repository with a current route of travel input into the navigation subsystem. In a third example of the system, optionally including one or both of the first and second examples, the controller predicts the upcoming data communication degradation by querying the dark-spot repository with a plurality of inferred routes of travel, wherein, the dark-spot repository returns to the external device interface data pertaining to one or more dark-spots along the plurality of inferred routes of travel. In a fourth example of the system, optionally including one or more or each of the first through third examples, the external device interface transmits an actual start location and an actual end location of the data communication degradation to an off-board system.

The disclosure also provides support for a method for a vehicle comprising: obtaining a current route of travel of the vehicle, determining a start location and an end location of an upcoming data communication degradation along the current route of travel, estimating a time of arrival of the vehicle at the start location of the upcoming data communication degradation based on vehicle operating conditions and conditions along the current route, estimating a duration of travel from the start location to the end location, determining a buffer size of a buffer based on a current rate of media content streaming via an infotainment system of the vehicle, and further based on the duration of travel from the start location to the end location, estimating a download duration to fill the buffer, and initiating buffer download at a time greater than the download duration prior to the time of arrival at the data communication degradation, and playing, via a media output device of the vehicle, content of the buffer while traveling from the start location to the end location of the upcoming data communication degradation. In a first example of the method, estimating the duration of travel from the start location to the end location is based on traffic conditions along the current route between the start location and the end location, a distance between the start location and end location, and further based on vehicle speed of the vehicle. In a second example of the method, optionally including the first example, estimating the download duration is based on the buffer size of the buffer and an average expected data bandwidth along the current route to the start location of the upcoming data communication degradation.

The description of embodiments has been presented for purposes of illustration and description. Suitable modifications and variations to the embodiments may be performed in light of the above description or may be acquired from practicing the methods. The methods may be performed by executing stored instructions with one or more logic devices (e.g., processors) in combination with one or more additional hardware elements, such as storage devices, memory, image sensors/lens systems, light sensors, hardware network interfaces/antennas, switches, actuators, clock circuits, etc. The described methods and associated actions may also be performed in various orders in addition to the order described in this application, in parallel, and/or simultaneously. Further, the described methods may be repeatedly performed. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects.

The following claims particularly point out subject matter from the above disclosure that is regarded as novel and non-obvious.

1. A method for managing streaming media content in a vehicle, comprising:
buffering streaming media content from a content provider in a data buffer in the vehicle, the buffer adjusted based on an upcoming data communication degradation; and
playing the buffered media content during an interrupted communication with the content provider.

2. The method of claim 1, wherein the upcoming data communication degradation is defined by a start location and an end location of data communication degradation.

3. The method of claim 2, wherein the start location and end location are used to generate an estimated time of arrival at the start location and a time duration for passing from the start location to the end location of the upcoming data communication degradation.

4. The method of claim 3, wherein a buffer size is adjusted based on one or more of the estimated time of arrival and the time duration for passing through the upcoming data communication degradation.

5. The method of claim 1, wherein the upcoming data communication degradation is defined by a start time and an end time of data communication degradation.

6. The method of claim 5, wherein an increased buffer size is filled before the start time of data communication degradation.

7. The method of claim 5, further comprising, suggesting an encoding technique to a user based on the start time and the end time of data communication degradation.

8. The method of claim 1, wherein after passing through the data communication degradation, one or more of an actual start time and an actual end time are provided to an off-board system.

9. The method of claim 1, wherein a plurality of possible routes are predicted and a longest data communication degradation is determined based on data for each of the plurality of possible routes.

10. The method of claim 9, wherein a buffer size is determined based on the longest data communication degradation.

11. The method of claim 1, wherein a buffer size is determined based on one or more of a current media content streaming rate, encoding technique, and quality of stream.

12. The method of claim 1, the method further comprising:
notifying a user that the streaming media is currently using escalated buffering while passing through data communication degradations.

13. An in-vehicle infotainment system, comprising;
an external device interface communicatively coupling the in-vehicle infotainment system with one or more off-board systems;
a media output device communicatively coupled to the external device interface; and
a controller with computer-readable instructions stored on non-transitory memory thereof that when executed cause the controller to:
predict an upcoming data communication degradation based on data received from an off-board system by the external device interface, wherein the upcoming data communication degradation is defined by a start location and an end location of an upcoming data communication degradation;
determine a time of arrival at the start location and a time duration for passing from the start location to the end location;
adjust dynamically a buffer size of a buffer of streaming media content being played by the media output device based on the time duration for passing from the start location to the end location;
fill the buffer prior to the time of arrival at the start location of the data communication degradation; and
play, via the media output device, contents of the buffer while passing from the start location to the end location of the data communication degradation.

14. The in-vehicle infotainment system of claim 13, wherein the external device comprises a dark-spot repository, and wherein the dark-spot repository stores a plurality of internet dark-spots indexed by location.

15. The in-vehicle infotainment system of claim 14, further comprising a navigation subsystem, and wherein the controller predicts the upcoming data communication degradation by querying the dark-spot repository with a current route of travel input into the navigation subsystem.

16. The in-vehicle infotainment system of claim 14, wherein the controller predicts the upcoming data communication degradation by querying the dark-spot repository with a plurality of inferred routes of travel, wherein, the dark-spot repository returns to the external device interface data pertaining to one or more dark-spots along the plurality of inferred routes of travel.

17. The in-vehicle infotainment system of claim 13, wherein the external device interface transmits an actual start location and an actual end location of the data communication degradation to an off-board system.

18. A method for a vehicle comprising:
obtaining a current route of travel of the vehicle;
determining a start location and an end location of an upcoming data communication degradation along the current route of travel;
estimating a time of arrival of the vehicle at the start location of the upcoming data communication degradation based on vehicle operating conditions and conditions along the current route;
estimating a duration of travel from the start location to the end location;
determining a buffer size of a buffer based on a current rate of media content streaming via an infotainment system of the vehicle, and further based on the duration of travel from the start location to the end location;
estimating a download duration to fill the buffer; and
initiating buffer download at a time greater than the download duration prior to the time of arrival at the data communication degradation; and
playing, via a media output device of the vehicle, content of the buffer while traveling from the start location to the end location of the upcoming data communication degradation.

19. The method of claim 18, wherein estimating the duration of travel from the start location to the end location is based on traffic conditions along the current route between the start location and the end location, a distance between the start location and end location, and further based on vehicle speed of the vehicle.

20. The method of claim 18, wherein estimating the download duration is based on the buffer size of the buffer and an average expected data bandwidth along the current route to the start location of the upcoming data communication degradation.
